(19) United States
(12) Patent Application Publication
(10) Pub. No.: US 2026/0295939 A1
(43) Pub. Date: Oct. 1, 2026

(54) PRINT BED FOR 3D PRINTING

(71) Applicant: Serge Sarkisian, Nazareth, PA (US)

(72) Inventor: Serge Sarkisian, Nazareth, PA (US)

(21) Appl. No.: 19/299,698

(22) Filed: Aug. 14, 2025

Related U.S. Application Data
(60) Provisional application No. 63/780,833, filed on Mar. 31, 2025.

(51) Int. Cl. B29C 64/245; B22F 12/00; B22F 12/17; B22F 12/30; B29C 64/232; B29C 64/295; B33Y 30/00

(52) U.S. Cl. CPC B29C 64/245; B22F 12/17; B22F 12/222; B22F 12/30; B29C 64/232; B29C 64/295; B33Y 30/00

(57) ABSTRACT

A print bed for 3D printing has at least one articulating support unit that can be selectively positioned at different elevations to support the printing of different workpieces having extended structures that begin to be printed before being connected to the workpiece's base structure. The articulating support unit reduces, or even eliminates, the amount of material needed to print temporary support structures for the extended structures, thereby reducing both wasted printing material and the time to print the workpiece. Multiple articulating support units can be configured together to provide a print bed assembly defining a relatively complex printing surface having build plates at multiple different elevations. Each articulating support unit has an independently controllable heating element to support the 3D printing process.

### CROSS-REFERENCE TO RELATED APPLICATIONS

This application claims the benefit of the filing date of U.S. provisional Application No. 63/780,833, filed on Mar. 31, 2025 as attorney docket no. 1454.001PROV, the teachings of which are incorporated herein by reference in their entirety.

### BACKGROUND

### Field of the Disclosure

The present disclosure relates to 3D printing and, more specifically but not exclusively, to print beds for 3D printing.

### Description of the Related Art

This section introduces aspects that may help facilitate a better understanding of the disclosure. Accordingly, the statements of this section are to be read in this light and are not to be understood as admissions about what is prior art or what is not prior art.

In 3D printing (also known as additive manufacturing), the structure being manufactured (referred to herein as the “workpiece”) is printed from the bottom up on a platform referred to as a print bed.

FIG. 1A is a side view of an example workpiece 100 made using a conventional 3D printing technique. As shown in FIG. 1A, the workpiece 100 has a base structure 102 that defines the bottom of the workpiece (i.e., the portion of the workpiece having the lowest elevation). The 3D printing of the workpiece 100 begins at the bottom and prints the base structure 102 layer by layer from the bottom up.

As shown in FIG. 1A, the workpiece 100 also has a (single) extended structure 106 that extends lower in elevation than a (single) intervening structure 104 of the workpiece 100 that connects the extended structure 106 to the base structure 102. As such, during 3D printing, the bottom of the extended structure 106 begins to be printed before any of the intervening structure 104 is printed. Note that the locations of the interfaces between the base structure 102 and the intervening structure 104 and between the intervening structure 104 and the extended structure 106 are somewhat arbitrary. However those structures are defined, the important point is that the bottom of the extended structure 106 begins to be printed before any of the intervening structure 104 is printed.

In order to physically support the initially printed, bottom portion of the extended structure 106, it is known to include in the printing of the workpiece 100, the printing of temporary support structure to support the bottom portion of the extended structure 106 until the intervening structure 104 begins to be printed that physically connects and sufficiently supports the extended structure 106 onto the base structure 102.

FIG. 1B is a side view of an intermediate stage in the conventional 3D printing of the workpiece 100 of FIG. 1A. Note that the 3D printer itself is not represented in FIG. 1B or in other analogous figures. As shown in FIG. 1B, in addition to printing the base structure 102, a bottom portion of the temporary support structure 108 has also been printed. Note that, depending on the implementation, the temporary support structure 108 may be printed using the same material used to print the workpiece 100 or a different material.

FIG. 1C is a side view of a later stage in the conventional 3D printing of the workpiece 100 of FIG. 1A. As shown in FIG. 1C, the temporary support structure 108 has been completed and provides physical support for the printing of the bottom portion of the extended structure 106 before any of the intervening structure 104 of FIG. 1A has been printed.

FIG. 1D is a side view of a still later stage in the conventional 3D printing of the workpiece 100 of FIG. 1A. As shown in FIG. 1D, more of the base structure 102 and more of the extended structure 106 have been printed as well as initial portions of the intervening structure 104.

FIG. 1E is a side view of the completed workpiece 100 of FIG. 1A (having the full base structure 102 and the full extended structure 106 with the full intervening structure 104) along with the full temporary support structure 108. As known in conventional 3D printing, the temporary support structure 108 can then be removed (e.g., cut off) to provide the desired workpiece 100.

### SUMMARY

As represented in FIG. 1E, the completed temporary support structure 108 consists of a relatively large mass of 3D printing material. Having to print the temporary support structure 108 is both time-consuming and wasteful of that 3D printing material. The present disclosure describes techniques for 3D printing that are less time-consuming and less wasteful than conventional 3D printing techniques for workpieces, such as workpiece 100 of FIG. 1A, having base structures connected by intervening structures to extended structures that extend lower than the corresponding intervening structures.

In some embodiments of the present disclosure, a 3D-printing print bed has one or more articulating support units that can be programmed to extend vertically (to the same or different elevations) to provide appropriate temporary support for the printing of one or more extended structures of a workpiece during the 3D printing process at least until those extended structures begin to be sufficiently connected to the workpiece's base structure(s) by the corresponding intervening structures. In this way, the amount of material needed to print any temporary support structure can be greatly reduced if not eliminated entirely. As a result, the workpiece can be 3D printed quicker and with less waste than with conventional 3D printing techniques.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1A is a side view of an example workpiece made using a conventional 3D printing technique;

FIG. 1B is a side view of an intermediate stage in the conventional 3D printing of the workpiece of FIG. 1A;

FIG. 1C is a side view of a later stage in the conventional 3D printing of the workpiece of FIG. 1A;

FIG. 1D is a side view of a still later stage in the conventional 3D printing of the workpiece of FIG. 1A;

FIG. 1E is a side view of the completed workpiece of FIG. 1A along with the temporary support structure;

FIG. 2A is a perspective view of a 3D-printing print bed support unit in its fully retracted configuration, according to certain embodiments of the present disclosure;

FIG. 2B is a perspective view of the print bed support unit of FIG. 2A in its fully extended configuration;

FIG. 3 is a perspective view of the piston of FIGS. 2A and 2B;

FIG. 4 is a perspective view of the frame of the print bed support unit of FIGS. 2A and 2B without the piston;

FIG. 5A is a perspective view of a 3D-printing print bed assembly comprising three instances of the print bed support unit of FIGS. 2A and 2B configured side by side;

FIG. 5B is a side view of the top of the print bed assembly of FIG. 5A after the initial portion of the workpiece of FIG. 1A has been printed;

FIG. 5C is a side view of the top of the print bed assembly of FIG. 5A after more of the workpiece of FIG. 1A has been printed;

FIG. 5D is a side view of the top of the print bed assembly of FIG. 5A after one of the articulating support units has been extended up to the level of the top of the partially printed workpiece;

FIG. 5E is a side view of the top of the print bed assembly of FIG. 5A after still more of the workpiece of FIG. 1A has been printed;

FIG. 5F is a side view of the top of the print bed assembly of FIG. 5A after the entire workpiece of FIG. 1A has been printed;

FIG. 6 is a side view of the articulating support of FIGS. 2A and 2B according to certain embodiments;

FIG. 7 is a perspective, exploded view of the articulating support of FIGS. 2A and 2B according to certain other embodiments;

FIG. 8 is a block diagram representing electrical components of the print bed support unit of FIGS. 2A and 2B;

FIG. 9 is a perspective view of an alternative, unitary, 3D-printing print bed of the present disclosure;

FIG. 10 is a perspective view of a print bed according to other embodiments of the disclosure;

FIG. 11 is a perspective view of a print bed according to other embodiments of the disclosure; and

FIG. 12 is a perspective view of a print bed according to other embodiments of the disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

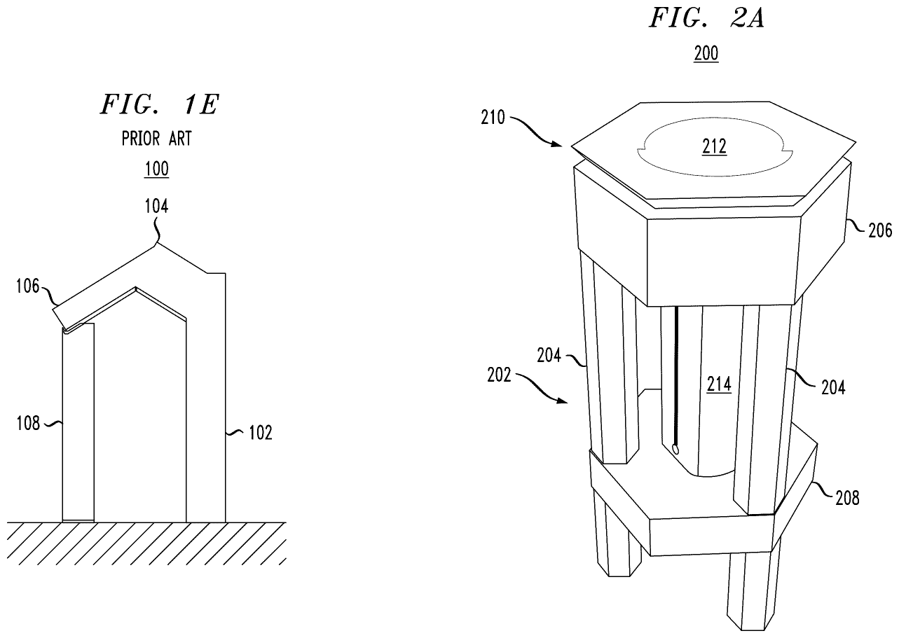

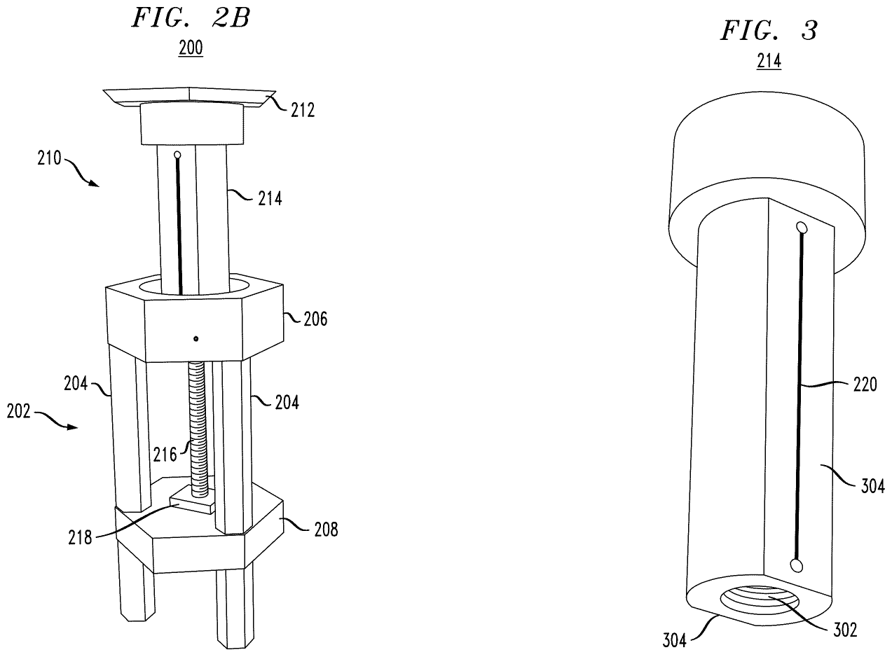

FIG. 2A is a perspective view of a 3D-printing print bed support unit 200 in its fully retracted configuration, and FIG. 2B is a perspective view of the print bed support unit 200 of FIG. 2A in its fully extended configuration, according to certain embodiments of the present disclosure. As described further below, in some implementations, the print bed support unit 200 can be controllably configured to be at any configuration between the fully retracted configuration of FIG. 2A and the fully extended configuration of FIG. 2B.

As shown in FIGS. 2A and 2B, print bed support unit 200 has a frame 202 having three legs 204 (only two of which are visible in the views of FIGS. 2A and 2B) and upper and lower tiers 206 and 208. In addition, the print bed support unit 200 has a articulating support 210 that can be selectively extended to any height (i.e., elevation) from the fully retracted configuration of FIG. 2A to the fully extended configuration of FIG. 2B. The articulating support 210 has a build plate 212, a threaded piston 214, a correspondingly threaded shaft 216, and a motor 218 that controllably rotates the shaft 216, which, in turn, raises and lowers the piston 214 and the build plate 212 depending on the direction of rotation of the shaft 216. In some implementations, the motor 218 is a servo or stepper motor, although any suitable motor may be used.

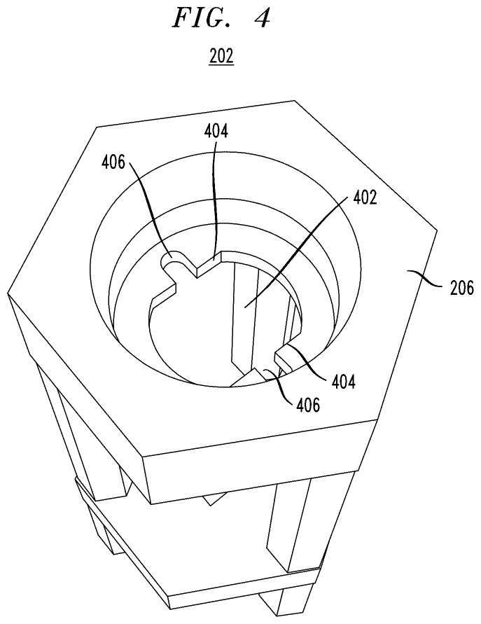

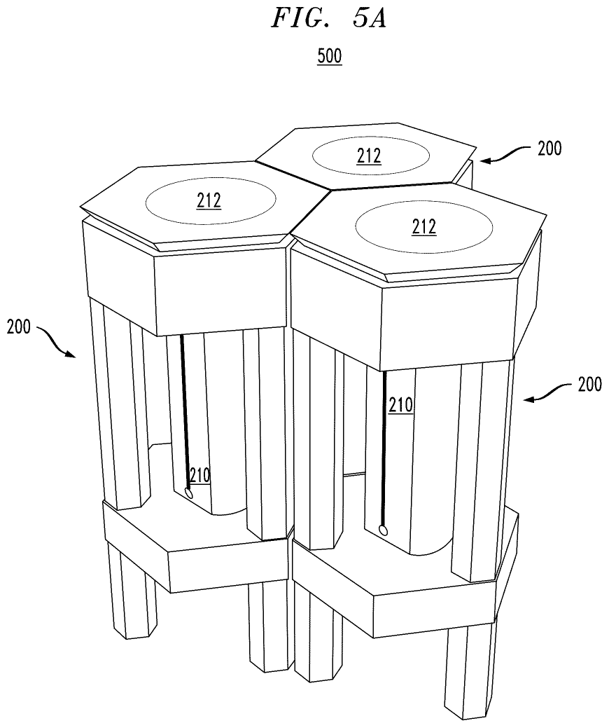

FIG. 3 is a perspective view of the piston 214 of FIGS. 2A and 2B showing its threaded opening 302. As shown in FIG. 3, the piston 214 has two opposing flat sides 304, each of which has a wire 220 running along its outer surface to provide electric power to one or more electrical components (e.g., heaters, lights) at the build plate 212.

Referring again to FIG. 2B, the motor 218 is mounted in the lower tier 208 and rotatably drives the threaded shaft 216 that engages with the correspondingly threaded opening 302 in the piston 214 of the articulating support 210.

FIG. 4 is a perspective view of the frame 202 of the print bed support unit 200 without the articulating support 210. As shown in FIG. 4, the upper tier 206 has an opening 402 with two opposing flat sides 404 that correspond to the opposing flat sides 304 of the piston 214, with each side 404 having a groove 406 to accommodate the wires 220 of FIG. 3.

The opposing, flat sides 304 of the piston 214 engage with the flat sides 404 in the opening 402 of the upper tier 206 to prevent the piston 214 from rotating with the threaded shaft 216, thereby converting rotation of the threaded shaft 216 into vertical extension/retraction of the articulating support 210 relative to the frame 202, depending on the direction of rotation of the threaded shaft 216.

In some implementations, the exposed wires 220 on the piston 214 are not insulated, and the grooves 406 in the opening 402 of the upper tier 206 have uninsulated positive- and negative-voltage terminals that physically contact the wires 220 as the piston 214 is raised and lowered within the frame 202 in order to provide electrical power to one or more electrical elements (e.g., heating element, lights) at the build plate 212 at the top of the articulating support 210.

As shown in FIGS. 2A and 2B, the upper and lower tiers 206 and 208 have hexagonal shapes that enable multiple instances of the print bed support units 200 to be configured side by side in a honeycomb pattern to form a print bed assembly having multiple, independently controllable articulating support units 210 that can be used to support the printing of a wide variety of workpieces having different shapes and sizes.

Those skilled in the art will understand that, in alternative embodiments, print bed support units of the present disclosure may have other shapes that enable multiple print bed support units to be configured together to form print bed assemblies, such as rectangular shapes and combinations of pentagons and hexagons as in a soccer ball pattern.

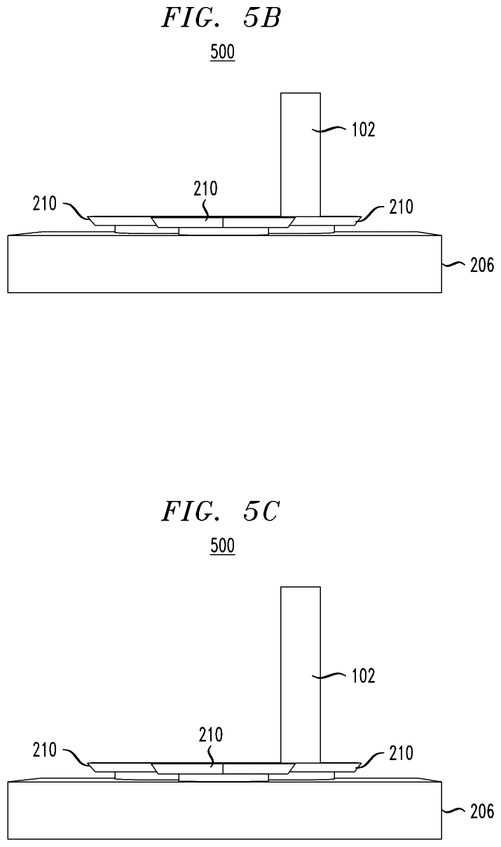

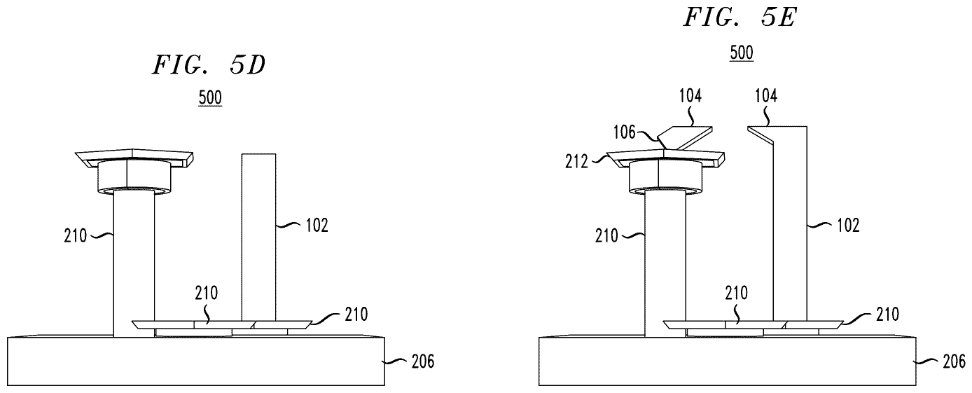

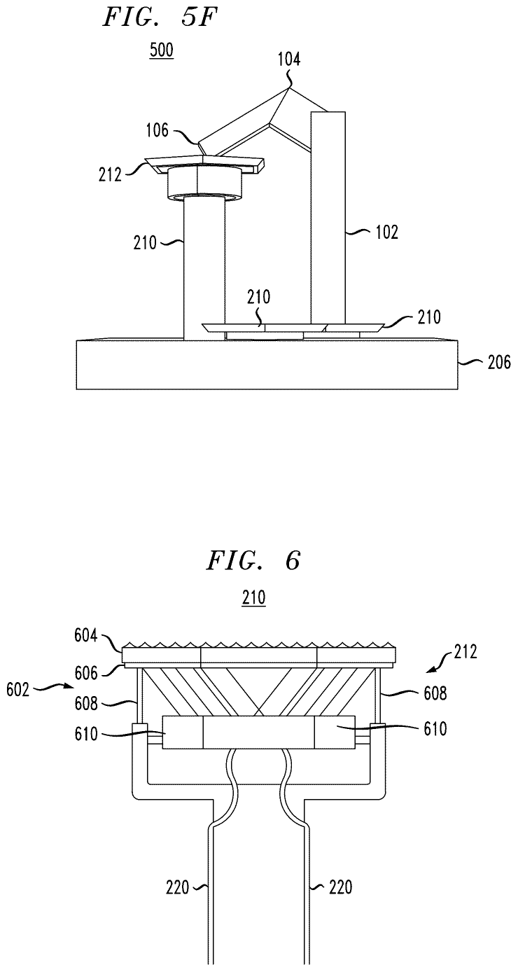

FIG. 5A is a perspective view of a 3D-printing print bed assembly 500 comprising three instances of the print bed support unit 200 of FIGS. 2A and 2B configured side by side. In FIG. 5A, all three articulating support units 210 are in their fully retracted configurations.

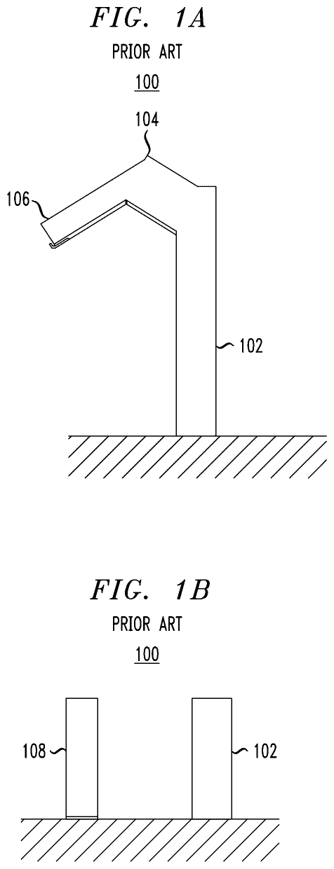

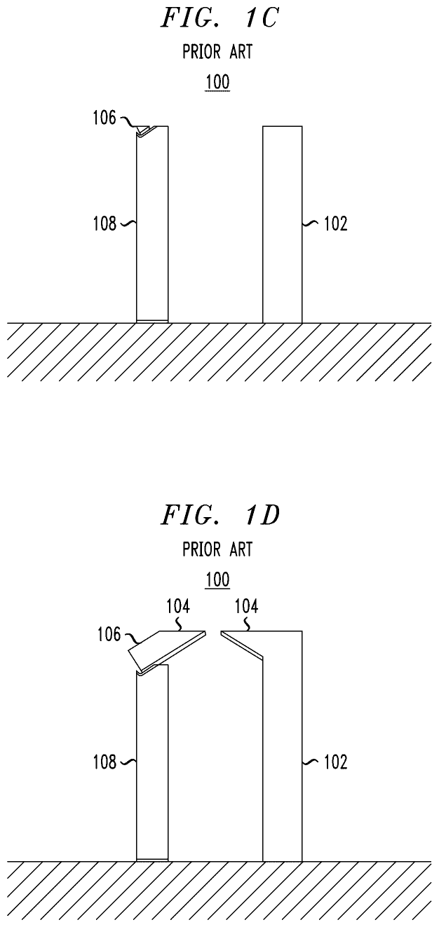

FIG. 5B is a side view of the top of the print bed assembly 500 of FIG. 5A after the initial portion of the workpiece 100 of FIG. 1A has been printed (corresponding to the stage of printing the workpiece 100 shown in FIG. 1B). Note that, as shown in FIG. 5B, all three articulating support units 210 remain in their fully retracted configurations. Note further that, in FIG. 5B, no temporary support structure has been 3D printed.

FIG. 5C is a side view of the top of the print bed assembly 500 of FIG. 5A after more of the workpiece 100 of FIG. 1A has been printed (corresponding to the stage of printing the workpiece 100 shown in FIG. 1C). Note that, as shown in FIG. 5C, all three articulating support units 210 still remain in their fully retracted configurations. Note further that, in FIG. 5C, still no temporary support structure has been 3D printed.

FIG. 5D is a side view of the top of the print bed assembly 500 of FIG. 5A after one of the articulating support units 210 has been extended up to the level of the top of the partially printed workpiece 100.

FIG. 5E is a side view of the top of the print bed assembly 500 of FIG. 5A after still more of the workpiece 100 of FIG. 1A has been printed (corresponding to the stage of printing the workpiece 100 shown in FIG. 1D). Note that, as shown in FIG. 5E, the initial portion of the extended structure 106 and an initial portion of the intervening structure 104 have been printed on the build plate 212 of the extended articulating support 210 with little or no temporary support structure needed.

FIG. 5F is a side view of the top of the print bed assembly 500 of FIG. 5A after the entire workpiece 100 of FIG. 1A has been printed. Note that, depending on the particular design of the workpiece 100, the workpiece 100 may be printed with only minimal temporary support structure needing to be printed or, in some cases, with no temporary support structure at all. Either way, the amount of 3D printing material used to print the workpiece 100 is greatly reduced, thereby also greatly reducing the time that it takes to print the workpiece 100.

Note that, as shown in FIGS. 2A, 2B, and 5A, the build plate 212 of each print bed support unit 200 also has a hexagonal shape and is sized such that, when the articulating support units 210 are all in their fully retracted configurations (as in FIG. 5A), the build plate 212 abut one another to form a contiguous, flat printing surface. As such, two or more articulating support units 210 in adjacent print bed support units 200 can be extended to the same height to form an elevated, contiguous, flat printing surface. Furthermore, in general, different articulating support units 210 can be extended to different heights to support the 3D printing of relatively complex workpieces.

As known in the art, 3D-printing print beds have heated surfaces to support the 3D printing process. According to certain embodiments of the present disclosure, the articulating support 210 of each print bed support unit 200 has an independently controllable heating element that selectively heats the corresponding build plate 212.

FIG. 6 is a side view of the articulating support 210 of FIGS. 2A and 2B according to certain embodiments. As shown in FIG. 6, the build plate 212 has a heating element 602 comprising (i) a hexagonal, textured, glass build plate 604 having a colored, photo-thermal bottom layer 606 and supported by support legs 608 and (ii) a set of (e.g., six), individually controllable light emitting diodes (LEDs) 610 that can be selectively illuminated to heat up corresponding portions of the glass build plate 604.

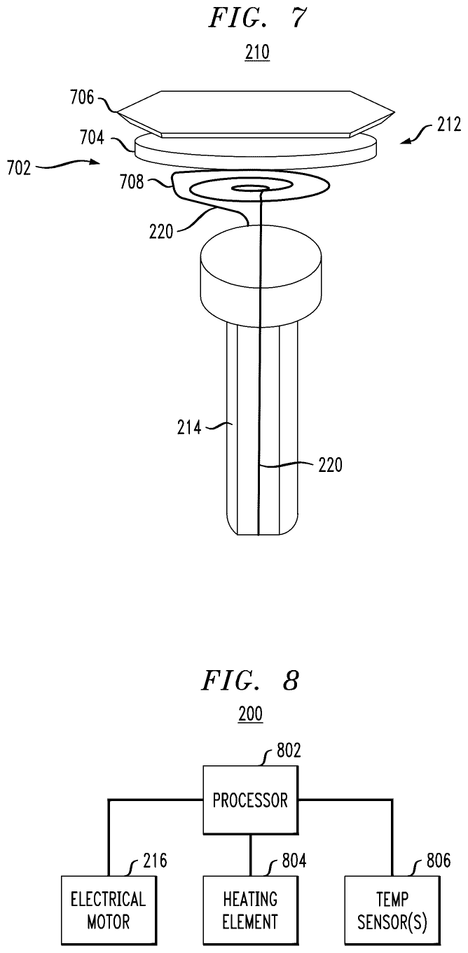

FIG. 7 is a perspective, exploded view of the articulating support 210 of FIGS. 2A and 2B according to certain other embodiments. As shown in FIG. 7, the build plate 212 has a heating element 702 comprising an insulator (e.g., room-temperature vulcanizing (RTV) silicone with high thermal conductivity) layer 704 between a hexagonal, textured, metal (e.g., stainless steel 316l) build plate 706 and an induction coil 708 that is embedded within the insulator layer 704 and powered to selectively heat the metal build plate 706.

FIG. 8 is a block diagram representing electrical components of the print bed support unit 200 of FIGS. 2A and 2B. As shown in FIG. 8, the print bed support unit 200 has a programmable (e.g., Arduino) processor 802 connected to (i) the electrical motor 218 of FIG. 2B, (ii) the heating element 804 (e.g., 602 in FIG. 6 or 702 in FIG. 7), and (iii) at least one (e.g., thermocouple) temperature sensor 806 configured to sense the temperature of the build plate (e.g., 604 of FIG. 6 or 706 of FIG. 7), where the processor 802 receives temperature signals from the temperature sensor(s) 806 and controls the operations of the electrical motor 218 and the heating element 804. Depending on the particular implementation, the processor 802 may control the electrical components of only a single print bed support unit 200, in which case, each print bed support unit 200 will have its own processor 802. Alternatively, the processor 802 may be shared to control the electrical components of multiple print bed support units 200 in a print bed assembly.

In some implementations, instead of having explicit temperature sensors 806, the processor 802 is configured to infer the temperature at the build plate based on the measured resistance of the heating element 804 and the measured voltage across the heating element 804 using the following formula:

$$R\_T = R\_ 0 * [ 1 + ∖ alpha * ( T - T\_ 0 ) ]$$

where:
R_T is the resistance at temperature T,
R_0 is the known resistance at a reference temperature T_0, and
\alpha is the temperature coefficient of resistance for that specific metal. The values of \alpha for stainless steel and titanium are approximately 0.001 1/K and 0.0026 1/° C., respectively.

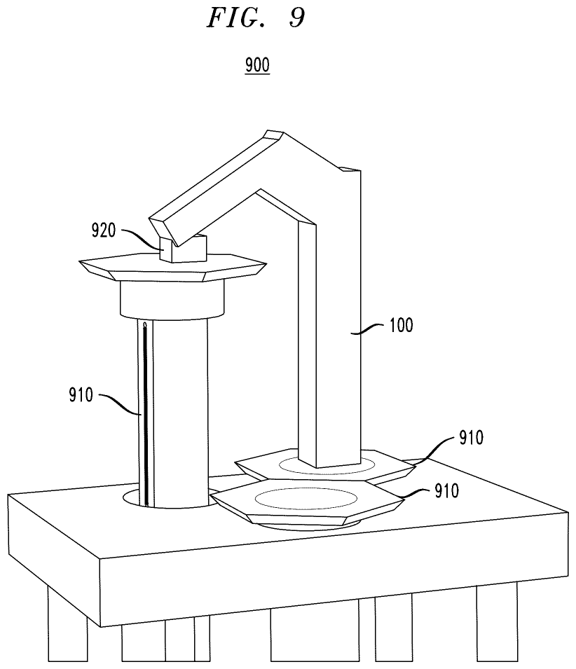

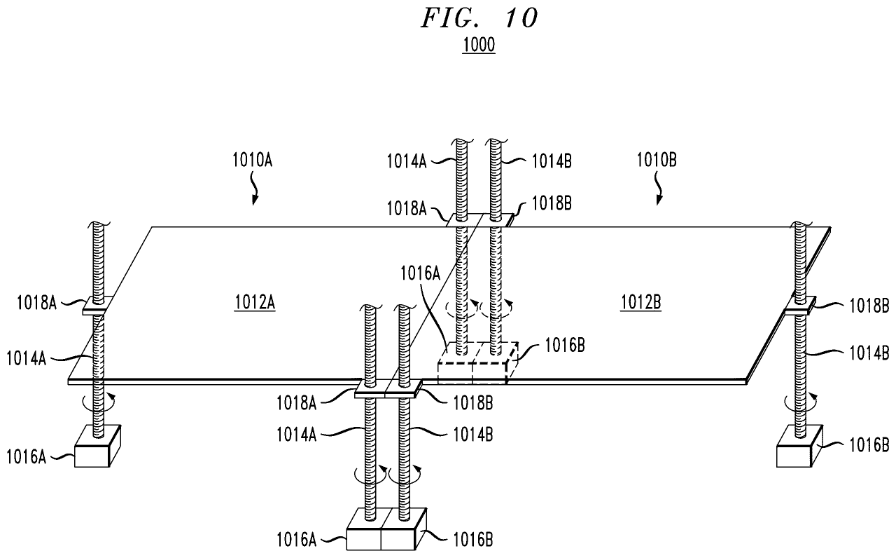

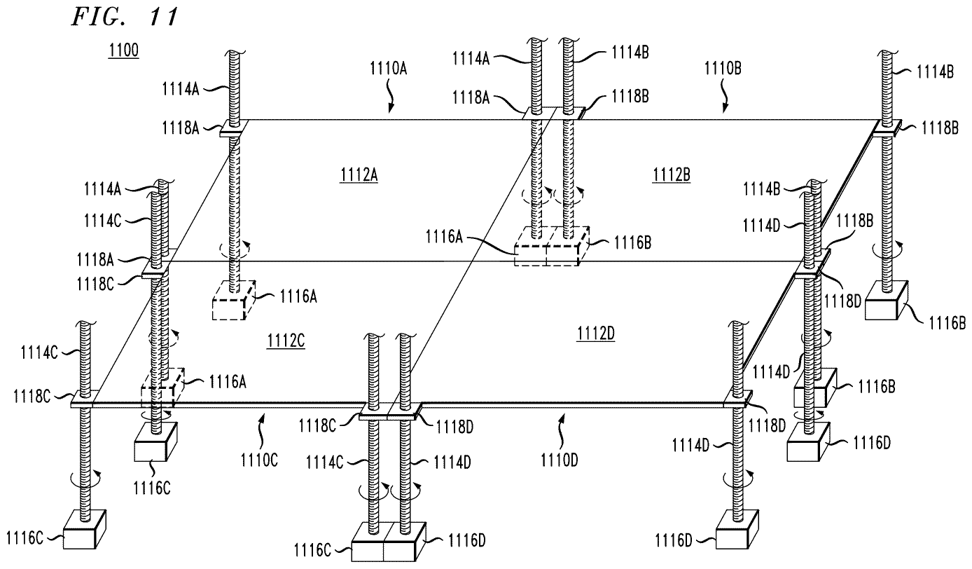

FIG. 9 is a perspective view of an alternative, unitary, 3D-printing print bed 900 of the present disclosure. Instead of configuring three different instances of the print bed support unit 200 of FIGS. 2A and 2B together to form the print bed assembly 500 of FIG. 5A, print bed 900 is a unitary structure having three articulating support units 910. FIG. 9 shows the result of printing the workpiece 100 of FIG. 1A, where one of the three articulating support units 910 has been extended to support the 3D printing of a relatively small amount of temporary support structure 920 for the workpiece 100. Those skilled in the art will understand that unitary, 3D-printing print beds of the present disclosure can be made with any suitable number of articulating support units 910.

FIG. 10 is a perspective view of a print bed 1000 according to other embodiments of the disclosure. Print bed 1000 has two articulating support units 1010A and 1010B, each support unit 1010 having a rectangular build plate 1012 supported by three threaded shafts 1014, each of which is rotated about its longitudinal axis by a motor 1016. Each build plate 1012 has three, rigidly connected, threaded, support structures 1018 that engage with the threading of the three corresponding threaded shafts 1014.

The three motors 1016 of each articulating support unit 1010 are driven at the same rate and in the same direction to rotate the three corresponding shafts 1014 to selectively raise or lower the corresponding build plate 1012 (depending on the direction of rotation of the motors 1016 and shafts 1014). In addition, the three motors 1016A of support unit 1010A may be driven independently of the three motors 1016B of support unit 1010B to configure the two build plates 1012A and 1012B at two different elevations analogous to the different elevations achievable by the print bed assemblies shown in FIGS. 5A and 9.

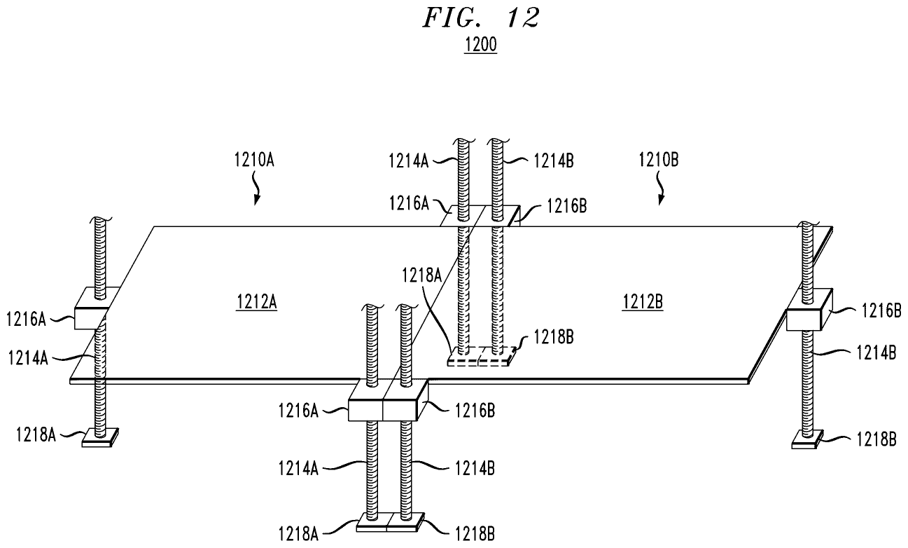

FIG. 11 is a perspective view of a print bed 1100 according to other embodiments of the disclosure. Print bed 1100 is analogous to print bed 1000 of FIG. 10, except that print bed 1100 has four articulating support units 1110A-1110D arranged in a (2×2) grid. As such, the four build plates 1112 can be driven by their corresponding motors 1116 to achieve any available combination of four independently selected elevations.

Note that, in print bed 1000, two of the three shafts 1014 of each support unit 1010 are located at adjacent corners of the build plate 1012 and the third shaft 1014 is located at the middle of the opposing side of the build plate 1012. In print bed 1100, the three shafts 1114 of each support unit 1110 are located at three corners of the build plate 1112. Those skilled in the art will understand that, in general, the shafts 1014/1114 may be configured at any suitable locations that (i) provide adequate support to the build plate 1012/1112 and (ii) avoid interference with the structures of other support units 1010/1110.

FIG. 12 is a perspective view of a print bed 1200 according to other embodiments of the disclosure. Print bed 1200 is analogous to print bed 1000 of FIG. 10, except that (i) the motors 1216 are rigidly connected to the corresponding build plates 1212 and (ii) the shafts 1214 do not rotate. Instead, as the three motors 1216 of each support unit 1210 are driven together, threading in the motors 1216 engages with the threading of the threaded shafts 1214 to raise or lower the support unit 1210 and its motors 1216 relative to the shafts 1214 and their support structures 1218. Here, too, the motors 1216A of support unit 1210A may be driven independently of the motors 1216B of support unit 1210B to achieve two different elevations for build plates 1212A and 1212B. Note that a print bed having a (2×2) grid of four support units analogous to the print bed 1100 of FIG. 11 can be based on configurations of motors and shafts similar to those in print bed 1200.

Note that, although not explicitly depicted in the figures, the print beds of FIGS. 10-12 may have processors, heating elements, and temperature sensors analogous to those shown in FIG. 8.

The present disclosure has been described in the context of specific embodiments. Those skilled in the art will understand that there are alternative embodiments that fall within the scope of the present disclosure. For example, different mechanisms can be used to extend and retract the articulating support units, such as (without limitation) a stepper motor with a straight gear mechanical actuator or a straight stepper solenoid actuator. There are also different mechanisms for heating the build plates such as an electromagnetic solenoid actuator.

Although the disclosure has been described in the context of print bed assemblies having multiple support units, where each support unit is an articulating support unit capable of being configured at different elevations, in some other embodiments, one or more support units may be articulating support units, while one or more other support units may be non-articulating support units having fixed elevations.

In certain embodiments, the present disclosure is a print bed for 3D printing, the print bed comprising a frame and at least one articulating support configured to be positioned at multiple different elevations relative to the frame.

In at least some of the above embodiments, the print bed further comprises a processor configured to control the articulating support to be able to be positioned at the multiple different elevations.

In at least some of the above embodiments, the processor is configured to position the articulating support at any selected elevation between a fully retracted configuration and a fully extended configuration.

In at least some of the above embodiments, the print bed comprises multiple, independently controllable articulating supports.

In at least some of the above embodiments, when the multiple articulating supports are all in fully retracted configurations, the multiple articulating supports form a contiguous, flat printing surface.

In at least some of the above embodiments, the articulating support has a controllable heating element that heats a build plate of the articulating support.

In at least some of the above embodiments, the heating element comprises one or more light emitting diodes (LEDs) that illuminate to heat the build plate.

In at least some of the above embodiments, the build plate is textured glass having a photo-thermal bottom layer.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A print bed for 3D printing, the print bed comprising two or more support units, wherein
at least one support unit is an articulating support unit configured to be positioned at multiple different elevations relative to at least one other support unit.

2. The print bed of claim 1, further comprising a processor configured to control the at least one articulating support unit to be able to be positioned at the multiple different elevations.

3. The print bed of claim 2, wherein the processor is configured to position the at least one articulating support unit at any selected elevation between a fully retracted configuration and a fully extended configuration.

4. The print bed of claim 1, the print bed comprising multiple, independently controllable articulating support units.

5. The print bed of claim 4, wherein, when the multiple articulating support units are all in fully retracted configurations, the multiple articulating support units form a contiguous, flat printing surface.

6. The print bed of claim 1, wherein the at least one articulating support unit has a controllable heating element that heats a build plate of the at least one articulating support unit.

7. The print bed of claim 6, wherein the heating element comprises one or more light emitting diodes (LEDs) that illuminate to heat the build plate.

8. The print bed of claim 7, wherein the build plate is textured glass having a photo-thermal bottom layer.

9. The print bed of claim 1, wherein the at least one articulating support unit comprises:
multiple threaded shafts that engage with corresponding, threaded support structures connected to a build plate of the support unit; and
corresponding motors connected to rotate the shafts to raise or lower the build plate.

10. The print bed of claim 1, wherein the at least one articulating support unit comprises:
multiple motors connected to a build plate of the support unit; and
corresponding threaded shafts that engage with the motors, wherein the motors are configured to be driven relative to the shafts to raise or lower the build plate.
